(19) United States
(12) Patent Application Publication
(10) Pub. No.: US 2015/0006664 A1
(43) Pub. Date: Jan. 1, 2015

(54) INFORMATION PROCESSOR, INFORMATION PROCESSING METHOD, AND COMPUTER PROGRAM PRODUCT

(71) Applicant: KABUSHIKI KAISHA TOSHIBA, Tokyo (JP)

(72) Inventor: Yasunori Aramaki, Hamura-shi (JP)

(73) Assignee: KABUSHIKI KAISHA TOSHIBA, Tokyo (JP)

(21) Appl. No.: 14/246,732

(22) Filed: Apr. 7, 2014

(30) Foreign Application Priority Data
Jun. 27, 2013 (JP) 2013-135362

(51) Int. Cl. H04L 29/08

(52) U.S. Cl. CPC H04L 67/2842
USPC 709/213

(57) ABSTRACT

According to one embodiment, an information processor includes an acquiring module, a downloading module, and a display controller. The acquiring module is configured to acquire first information of a program. The downloading module is configured to download a web page using the first information before broadcasting of the program, and to store the downloaded web page in a storage module. The display controller is configured to display the web page when there is a match between a web page retrieved using input information and the web page.

### CROSS-REFERENCE TO RELATED APPLICATIONS

This application is based upon and claims the benefit of priority from Japanese Patent Application No. 2013-135362, filed Jun. 27, 2013, the entire contents of which are incorporated herein by reference.

### FIELD

Embodiments described herein relate generally to an information processor, an information processing method, and a computer program product.

### BACKGROUND

There has been disclosed a technique to automatically download updated web page data based on update information received from an RSS reader, without requiring user operation.

For the case when an interesting topic is introduced during broadcasting of a program, there exists a technique to access a web page that is to be retrieved by using the topic. However, if many viewers attempt to access a single web page concurrently during broadcasting of the program, the concentration of the access to the specific web page may result in unable to view the web page. Here, the web page can immediately be viewed at the timing such as immediately before or one day after the program is broadcasted because there are a small number of accesses to the web page. However, it may be stressful for the user that he or she is unable to view the web page when he or she wants to view the web page during broadcasting of the program.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram illustrating a configuration of an information processor according to an embodiment;

FIG. 2 is an exemplary block diagram illustrating a functional configuration of the information processor in the embodiment;

FIG. 3 is an exemplary flowchart illustrating a web page downloading process with the information processor in the embodiment;

FIG. 4 is an exemplary diagram of retrieval coefficients stored according to categories of programs, in the embodiment;

FIG. 5 is an exemplary flowchart illustrating a web page display process with the information processor in the embodiment; and

FIG. 6 is an exemplary graph illustrating changes in the number of accesses to a web page before and during broadcasting of an information program, in the embodiment.

### DETAILED DESCRIPTION

In general, according to one embodiment, an information processor comprises an acquiring module, a downloading module, and a display controller. The acquiring module is configured to acquire first information of a program. The downloading module is configured to download a web page using the first information before broadcasting of the program, and to store the downloaded web page in a storage module. The display controller is configured to display the web page when there is a match between a web page retrieved using input information and the web page.

An information processor, an information processing method, and a computer program product according to an embodiment will be described below with reference to the accompanying drawings.

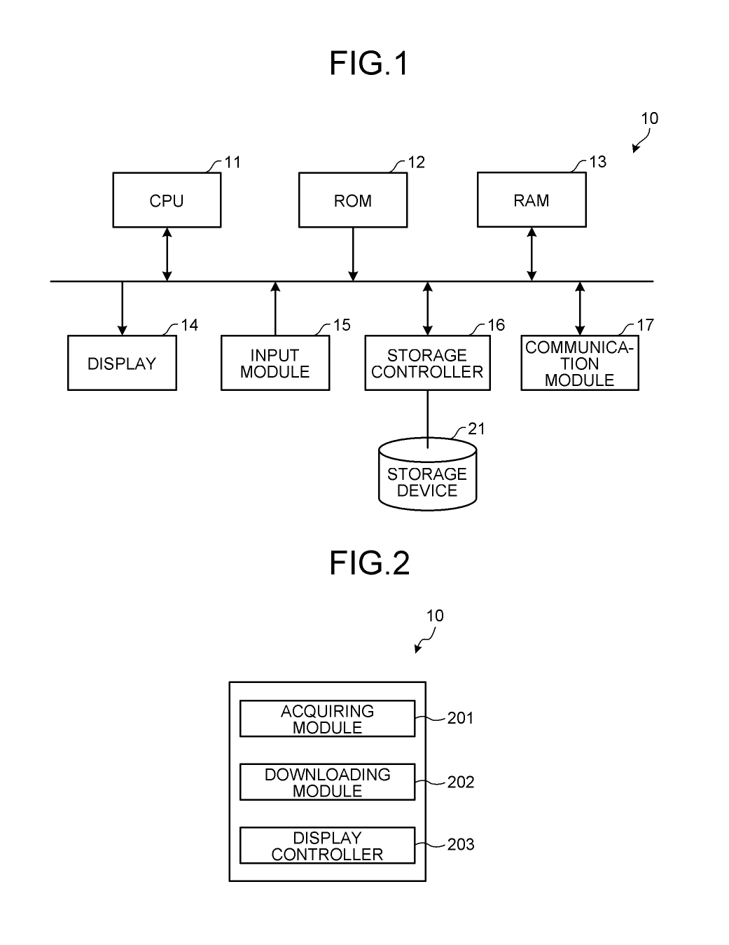

FIG. 1 is a block diagram illustrating a configuration of the information processor according to an embodiment. As illustrated in FIG. 1, an information processor 10 is a device that can download a web page through a network, such as the Internet, and display the web page. Examples of such a device include a smartphone, a personal computer (PC), a tablet terminal, and a portable telephone. In the embodiment, the information processor 10 comprises a central processing unit (CPU) 11, a read only memory (ROM) 12, a random access memory (RAM) 13, a display 14, an input module 15, a storage controller 16, a communication module 17, and a storage device 21.

The CPU 11 uses the RAM 13 as a work area, and performs various types of processing through cooperation with various computer control programs stored in, for example, the ROM 12. Then, the CPU 11 controls operations of each component configuring the information processor 10 as a whole.

The ROM 12 non-rewritably stores therein, for example, computer programs and various types of setting information relating to control of the information processor 10. The RAM 13 is a volatile storage medium that functions as a work area for the CPU 11.

The display 14 comprises a display unit, such as a liquid crystal display (LCD), and displays progress and results of processing, and the like, according to the control by the CPU 11.

The input module 15 comprises an input device, such as a keyboard and a mouse, and notifies the CPU 11 of a command or information from the user input through the input device.

The storage controller 16 controls operations of the storage device 21. The storage controller 16 performs a process according to a requirement, such as writing and reading data input from the CPU 11, relative to the storage device 21. It is noted that the storage device 21 has a recording medium, such as a magnetic disk, a semiconductor memory, and an optical disk.

The communication module 17 is a wired or wireless communication interface that establishes communication with an external device not illustrated and transmits and receives data.

FIG. 2 is a block diagram illustrating a functional configuration of the information processor according to the embodiment. The information processor 10 realizes an acquiring module 201, a downloading module 202, and a display controller 203 by causing the CPU 11 to execute computer programs stored in the ROM 12 as illustrated in FIG. 2. Specifically, the acquiring module 201 acquires program-related information (related information) relating to a program before being broadcasted. The downloading module 202 downloads a web page retrieved using the program-related information, and stores the downloaded web page in the storage device 21. The display controller 203 displays the web page stored in the storage device 21 on the display 14, if there is a match between a web page retrieved using information input through the input module 15 and the web page stored in the storage device 21.

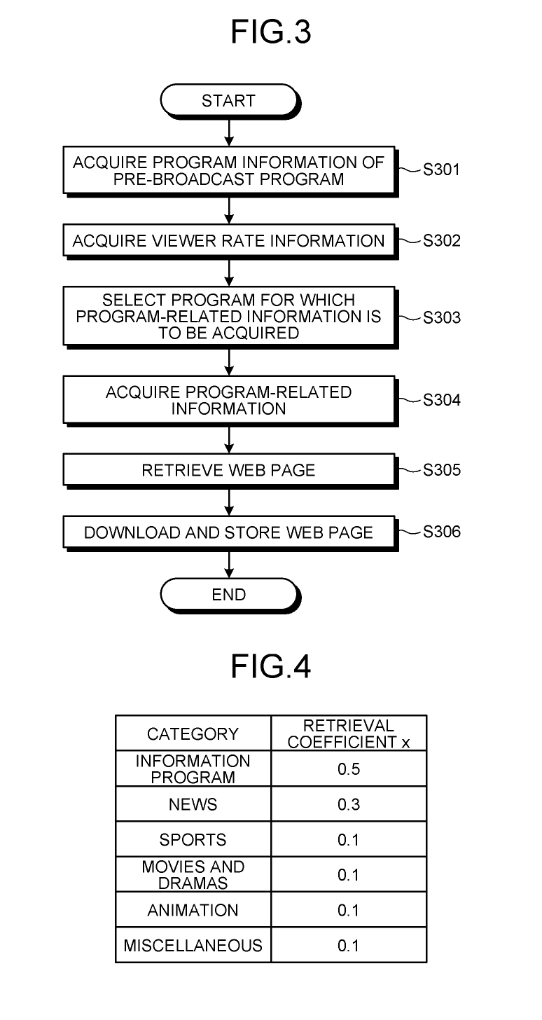

The following describes a web page downloading process in the information processor 10 according to the embodiment, with reference to FIGS. 2 to 4. FIG. 3 is a flowchart illustrating the web page downloading process in the information processor according to the embodiment. FIG. 4 is a diagram illustrating exemplary retrieval coefficients stored according to the categories of program.

The acquiring module 201 acquires program information (e.g., a program name, time and date of broadcasting the program, category of the program, and broadcast content of the program) of the program before broadcasting (hereinafter referred to as a “pre-broadcast program”) (S301). In the embodiment, the acquiring module 201 acquires service information (SI) of the pre-broadcast program from a server on the network and acquires electronic program guide (EPG) information contained in the acquired service information as the program information. In addition, the acquiring module 201 acquires viewer rate information that indicates a viewer rate of a past program relating to the pre-broadcast program (e.g., a program already broadcasted having the same program name as that of the pre-broadcast program and a program already broadcasted of the same category as that of the pre-broadcast program) or an viewer rate of the same time slot as that in which the pre-broadcast program is to be broadcasted (S302).

In the embodiment, if there is a past program relating to the pre-broadcast program (e.g., the pre-broadcast program is a serial drama), the acquiring module 201 acquires the viewer rate information that indicates the viewer rate of the past program. If there is no past program relating to the pre-broadcast program (e.g., the pre-broadcast program is a special program), the acquiring module 201 acquires the viewer rate information that indicates the viewer rate of the same time slot as that in which the pre-broadcast program is to be broadcasted (e.g., an average viewer rate of the same time slot as that in which the pre-broadcast program is to be broadcasted, an viewer rate of the same time slot of the preceding week as that in which the pre-broadcast program is to be broadcasted).

Then, the acquiring module 201 selects, from among a plurality of pre-broadcast programs, a program for which the program-related information is to be acquired based on the categories of the pre-broadcast programs and the viewer rates indicated by the viewer rate information (S303). In the embodiment, the acquiring module 201 calculates, for each of the pre-broadcast programs, an estimated number of people who perform retrieval of a web page using the program-related information of the each of the pre-broadcast programs based on the category of the each of the pre-broadcast program and the viewer rate indicated by the viewer rate information.

Specifically, the ROM 12 stores therein a retrieval coefficient used for the calculation of the estimated number of people who perform retrieval for each category of program. For example, as illustrated in FIG. 4, the ROM 12 stores therein a retrieval coefficient x used for the calculation of the estimated number of people who perform retrieval for each of different categories of programs, specifically, “information program”, “news”, “sports”, “movies and dramas”, “animation”, and “miscellaneous”. The acquiring module 201 first calculates an estimated number of people z using expression (1) given below, where, y is the viewer rate indicated by the acquired viewer rate information and a is a constant.

z=a×x×y (1)

Based on the estimated number of people who perform retrieval calculated for each of the pre-broadcast programs, the acquiring module 201 selects the pre-broadcast program for which the program-related information is to be acquired. For example, the acquiring module 201 selects, from among the pre-broadcast programs, a predetermined number of programs in descending order of the calculated estimated number of people who perform retrieval as the pre-broadcast programs for which the program-related information is to be acquired.

In the embodiment, the acquiring module 201 selects the pre-broadcast programs for which the program-related information is to be acquired based on the calculated estimated number of people who perform retrieval. This is, however, not the only possible arrangement and the acquiring module 201 may otherwise select the pre-broadcast programs for which the program-related information is to be acquired as long as the selection is made based on the category of the pre-broadcast program and the viewer rate indicated by the viewer rate information. For example, the acquiring module 201 may select, from among the pre-broadcast programs, programs that fall within a predetermined category of program (e.g., information program) and have a predetermined viewer rate (e.g., 5%) or higher as the viewer rate indicated by the viewer rate information as the programs for which the program-related information is to be acquired.

Next, the acquiring module 201 acquires the program-related information relating to the selected pre-broadcast programs (e.g., a keyword, such as a performer included in the broadcast content of the program) (S304). In the embodiment, if the acquired program information contains broadcast content, the acquiring module 201 acquires as the program-related information a keyword included in the program information (broadcast content) of the selected pre-broadcast programs among pieces of acquired program information. In the embodiment, the acquiring module 201 acquires the keyword (program-related information) from the broadcast content contained in the acquired program information. This is, however, not the only possible arrangement; alternatively, the acquiring module 201 may acquire the program-related information from an external device connected through, for example, a network.

In addition, in the embodiment, the acquiring module 201 acquires the program-related information of the selected pre-broadcast programs. This is, however, not the only possible arrangement. For example, the acquiring module 201 may acquire the program-related information of all pre-broadcast programs. Alternatively, the acquiring module 201 may acquire the program-related information of the pre-broadcast programs that are to be broadcasted for a predetermined period of time that begins with the present and ends with certain later time (e.g., for one week starting today).

The downloading module 202 uses the program-related information acquired by the acquiring module 201 to search through web pages available on the network (S305). Then, the downloading module 202 downloads the retrieved web pages before the broadcasting of the pre-broadcast programs, and stores the downloaded web pages in the storage device 21 (S306). In the embodiment, the downloading module 202 downloads the web pages retrieved by its own retrieval function. Nonetheless, the downloading module 202 may alternatively request an external device connected over a network to retrieve web pages using the acquired program-related information and download the web pages retrieved by the retrieval function of the external device.

Additionally, in the embodiment, the downloading module 202 downloads the web pages based on a display priority order in a list that displays a retrieval result of the web pages retrieved using the program-related information. For example, the downloading module 202 downloads the web pages up to the top ten positions in the list. This allows only the web pages that are highly likely to be retrieved during the broadcasting of the program to be downloaded.

Alternatively, the downloading module 202 may download the web pages stored in a server having a low throughput out of the web pages retrieved using the program-related information. Specifically, the information processor 10 stores in advance a predetermined server that is capable of downloading a web page even if access is concentrated on that particular web page. If a web page retrieved using the program-related information is stored in any server other than the predetermined server, the information processor 10 determines that the server that stores therein the web page retrieved using the program-related information is one having a low throughput and downloads the web page before the broadcasting. This enables the web page stored in the server having a low throughput to be also displayed, even if access is concentrated on the web page stored in the server having the low throughput during the broadcasting of the program.

In the embodiment, the downloading module 202 downloads the web page retrieved using the program-related information for a plurality of times before the broadcasting of the program associated with the program-related information and updates the web page previously stored in the storage device 21 with the web page downloaded last. At this time, the downloading module 202 may download the web page at predetermined time intervals before the broadcasting of the program; alternatively, if an update time and date (a time stamp) of the web page to be downloaded is later than an update time and date (a time stamp) appended to the web page previously stored in the storage device 21, the downloading module 202 may download the web page to be downloaded. Specifically, if the web page retrieved using the program-related information is updated before the broadcasting of the pre-broadcast program, the downloading module 202 downloads the web page for a plurality of times before the broadcasting of the pre-broadcast program.

Additionally, in the embodiment, the downloading module 202 has the storage device 21 of the information processor 10 store the downloaded web pages. This is, however, not the only possible arrangement. Alternatively, the downloaded web page may instead be stored in an external storage.

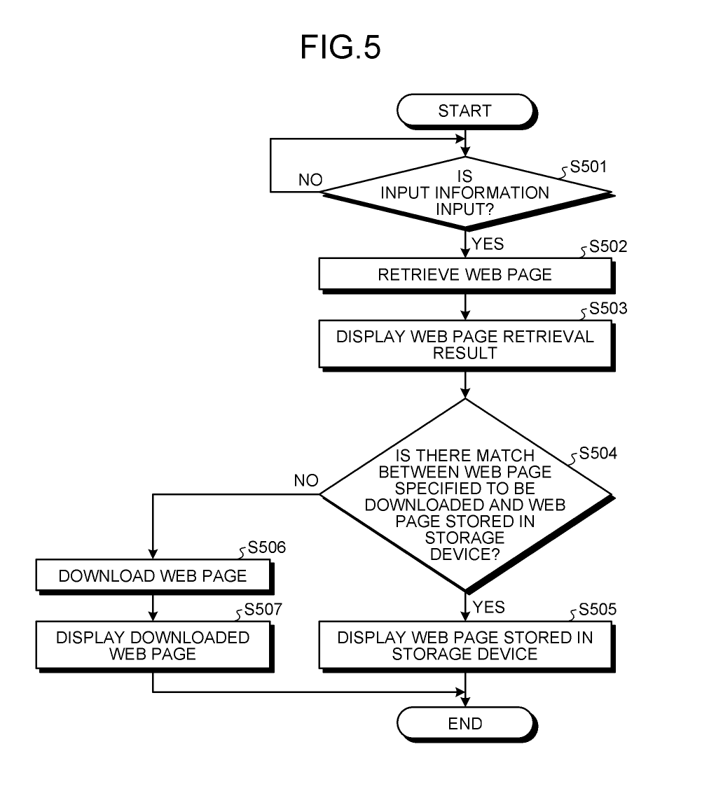

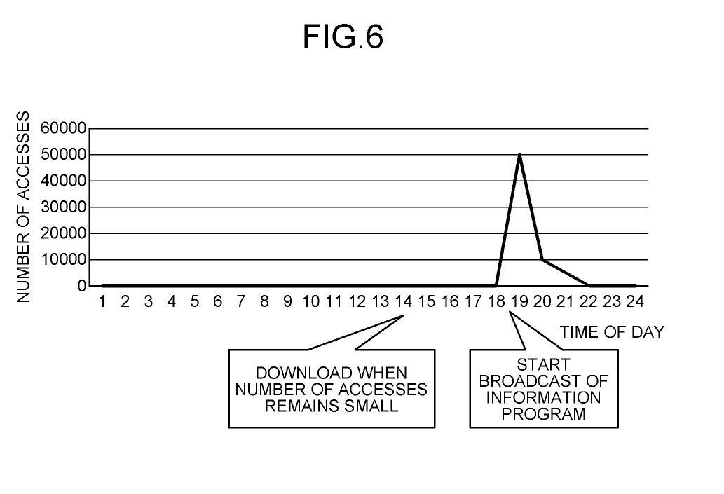

The following describes a web page display process with reference to FIGS. 2, 5, and 6. FIG. 5 is a flowchart illustrating the web page display process in the information processor in the embodiment. FIG. 6 is a graph illustrating changes in the number of accesses to a web page before and during broadcasting of an information program.

When input information used for the retrieval of the web page is input from the input module 15 (Yes at S501), the downloading module 202 uses the input information to search through web pages available on the network (S502). In the embodiment, the downloading module 202 uses its own retrieval function to search through the web pages. Nonetheless, the downloading module 202 may alternatively request an external device connected over a network to retrieve the web pages using the input information input thereto and acquire a retrieval result of the web pages by the retrieval function of the external device.

The display controller 203 causes the display 14 to display the retrieval result of the web pages retrieved using the input information (S503). The display controller 203 then determines, with respect to the retrieval result of the web pages displayed on the display 14, whether there is a match between the web pages specified to be downloaded through the input module 15 and the web pages stored in the storage device 21 (S504).

If there is a match between the web pages specified to be downloaded through the input module 15 and the web pages stored in the storage device 21 (Yes at S504), the display controller 203 causes the display 14 to display, out of the web pages stored in the storage device 21, the web page that matches a web page specified to be downloaded through the input module 15 (S505). Should access be concentrated on a web page retrieved using a keyword broadcast during a program, the foregoing arrangement enables the display 14 to display the web page using the web page stored in the storage device 21. A user of the information processor 10 therefore can enjoy stress-free viewing of the web page.

With reference FIG. 6, for example, after broadcasting of an information program is started, even if there is an increase in the number of accesses to the web pages retrieved using the keyword broadcast during the information program, the display controller 203 can cause the display 14 to display a web page by using the web page downloaded and stored in the storage device 21 at the time before the information program is on the air, at which the number of accesses to the web page remains small. Thus, the user of the information processor 10 can enjoy stress-free viewing of the web page even during the broadcasting of the information program.

If a web page that matches one of the web pages specified to be downloaded through the input module 15 is not stored in the storage device 21 (No at S504), the downloading module 202 downloads the web page specified to be downloaded (S506). The display controller 203 then causes the display 14 to display the downloaded web page (S507).

As described heretofore, with the information processor 10 in the embodiment, even if access is concentrated on a web page retrieved using a keyword broadcast while a program is on the air, the web page can be displayed on the display 14 using the web page stored in the storage device 21. Therefore, the user of the information processor 10 can enjoy stress-free viewing of the web page.

A computer program to be executed by the information processor 10 of the embodiment may be provided by being recorded on a computer-readable recording medium, such as a CD-ROM, a flexible disk (FD), a CD-R, and a digital versatile disk (DVD), in a file in an installable format or an executable format.

The computer program to be executed by the information processor 10 of the embodiment may also be configured so as to be stored in a computer connected to a network such as the Internet and to be downloaded over the network. The computer program to be executed by the information processor 10 of the embodiment may still be configured so as to be provided or distributed over a network such as the Internet.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor comprising:
an acquiring module configured to acquire first information of a program;
a downloading module configured to download a web page using the first information before broadcasting of the program, and to store the downloaded web page in a storage module; and
a display controller configured to display the web page when there is a match between a web page retrieved using input information and the web page.

2. The information processor of claim 1, wherein the acquiring module is configured to select the program for which the first information is to be acquired based on a category of the program and a viewer rate of a past program relating to the program or a viewer rate of an identical time slot.

3. The information processor of claim 1, wherein the acquiring module is configured to calculate, for each of programs before broadcasting, an estimated number of people who perform retrieval of a web page using first information of each of the programs based on a category of each of the programs and a viewer rate of a past program relating to each of the programs or a viewer rate of an identical time slot, and select from the programs, a first program for which the first information is to be acquired based on the estimated number of people.

4. The information processor of claim 1, wherein the downloading module is configured to download the web page based on a display priority order in a list configured to display a retrieval result of the web page retrieved using the first information.

5. The information processor of claim 1, wherein
the retrieved web page comprises a plurality of web pages, and
the downloading module is configured to download at least one of the web pages of a sight of a low throughput.

6. The information processor of claim 1, wherein the downloading module is configured to download the web page using the first information for a plurality of times before the broadcasting of the corresponding program.

7. The information processor of claim 6, wherein the downloading module is configured to download the web page using the first information for a plurality of times before the broadcasting of the program when the web page is updated before the broadcasting of the corresponding program.

8. An information processing method performed by an information processor, the information processing method comprising:
acquiring first information of a program;
downloading a web page using the first information before the broadcasting of the program;
storing the downloaded web page in a storage module; and
displaying the web page stored in the storage module when there is a match between a web page retrieved using input information and the web page.

9. A computer program product having a non-transitory computer readable medium including programmed instructions, wherein the instructions, when executed by a computer, cause the computer to perform:
acquiring first information of a program;
downloading a web page using the first information before the broadcasting of the program;
storing the downloaded web page in a storage module; and
displaying the web page stored in the storage module when there is a match between a web page retrieved using input information and the web page.
